(19) United States
(12) Patent Application Publication
(10) Pub. No.: US 2011/0198852 A1
(43) Pub. Date: Aug. 18, 2011

(54) ENERGY CONVERTER BASED ON POLYURETHANE SOLUTIONS

(75) Inventors: Werner Jenninger, Koln (DE); Sebastian Dörr, Dusseldort (DE); Joachim Wagner, Koln (DE)

(73) Assignee: Bayer MaterialScience AG, Leverkusen (DE)

(21) Appl. No.: 13/126,189

(22) PCT Filed: Oct. 20, 2009
(86) PCT No.: PCT/EP09/07489

§ 371 Date: Apr. 27, 2011

(30) Foreign Application Priority Data
Oct. 30, 2008 (EP) 08018936.8

(51) Int. Cl. F03B 13/00; H02K 15/00

(52) U.S. Cl. 290/53; 29/596

(57) ABSTRACT

The present invention relates to a method for producing electromechanical converters, to the use of solutions of at least one polyurethane in one or more organic solvents to produce electromechanical converters, to electromechanical converters produced therefrom and to the use of such electromechanical converters.

The present invention relates to a process for the production of electromechanical converters, the use of solutions of at least one polyurethane in one or more organic solvents for the production of electromechanical converters, electromechanical converters produced therefrom and the use of such electromechanical converters.

Converters—also called electromechanical converters—convert electrical energy into mechanical energy and vice versa. They can be employed as a constituent of sensors, actuators and generators.

The fundamental construction of such a converter comprises a layer of the electroactive polymer, which is coated with electrodes on both sides, as is described, for example, in WO-A 01/06575. This fundamental construction can be employed in the most diverse configurations for the production of sensors, actuators or generators.

Converters which contain various polymers as a constituent of the electroactive layer are described in the prior art, see, for example, in WO-A 01/06575.

However, the use of solutions of at least one polyurethane in one or more organic solvents for the production of the electroactive layer in converters has not yet been described.

The use of such polymer solutions as a starting basis for the production of elastic electroactive layers in converters has various advantages, and in particular they are easy to handle and in general can be processed at temperatures between room temperature and 100° C., so that heat-sensitive substrates can also be coated. One-component processing is furthermore as a rule possible.

The object of the present invention was therefore to provide novel elastic insulating electroactive layers for electromechanical converters which have advantageous properties. In particular, they should render simple processing possible and have advantageous mechanical properties.

It has now been found that film-forming compositions based on solutions of at least one polyurethane in one or more organic solvents are particularly suitable for the production of elastic electroactive layers for electromechanical converters having a high specific resistivity in the region of more than 10¹² ohm·cm. Such solutions are easy to process and the use of multi-component systems for the production of the layers can be avoided. Surprisingly, layers produced in this way show outstanding mechanical properties and a low water uptake capacity'.

If the water uptake capacity is high, water can act as a plasticizer, for example, and modify the mechanical profile of the materials employed. Furthermore, the electrical insulation of the electrodes by the polymer is no longer necessarily guaranteed if the water uptake is high and a very high (electrical) voltage is applied. These disadvantages can be avoided by the surprisingly low water uptake capacity. The low water uptake capacity offers the advantage, in particular, that functioning of the electromechanical converter is independent of the atmospheric humidity.

The present invention therefore provides a process for the production of a converter for conversion of electrical energy into mechanical energy or of mechanical energy into electrical energy, which comprises at least two electrodes and at least one polymer layer arranged between the electrodes, wherein the polymer layer is produced from a solution containing at least one polyurethane in one or more organic solvents, wherein the solution originates from a prepolymerization process with the following steps:
preparation of isocyanate-functional prepolymers from
   A1) organics poly isocyanates,
   A2) polymeric polyols and
   A3) optionally hydroxy-functional compounds and
B) complete or partial reaction of the free NCO groups of the prepolymer from A) with
B1) amino-functional compounds,
the prepolymers being dissolved in one or more organic solvents before, during and/or after step B).

The present invention furthermore provides the use of a solution containing at least one polyurethane in one or more organic solvents for the production of a converter for conversion of electrical energy into mechanical energy or of mechanical energy into electrical energy, which comprises at least two electrodes and a polymer layer arranged between the electrodes, characterized in that the polymer layer is produced from the solution containing at least one polyurethane in one or more organic solvents.

The present invention furthermore provides a converter for conversion of electrical energy into mechanical energy or of mechanical energy into electrical energy, which comprises at least two electrodes and a polymer layer arranged between the electrodes, characterized in that the polymer layer is produced from a solution containing at least one polyurethane in one or more organic solvents.

The solution containing at least one polyurethane in one or more organic solvents for the production of the polymer layer is also called film-forming composition or polyurethane solution for short in the following.

The polymer layer which is produced according to the invention from a solution containing at least one polyurethane in one or more organic solvents is the electroactive layer or a part of the electroactive layer of an electromechanical converter.

All known polyurethane solutions in principle can be employed as the film-forming compositions to be used.

Polyurethane solutions which are particularly preferably to be employed are obtainable by a prepolymerization process in which
A) isocyanate-functional prepolymers are prepared from
   A1) organic polyisocyanates
   A2) polymeric polyols having number-average molecular weight of from 400 to 8,000 g/mol, preferably 400 to 6,000 g/mol and particularly preferably from 600 to 3,000 g/mol and OH functionalities of from 1.5 to 6, preferably 1.8 to 3, particularly preferably from 1.9 to 2.1, and
   A3) optionally hydroxy-functional compounds having molecular weights of from 62 to 399 g/mol and
B) the free NCO groups of the prepolymers from A) are then reacted completely or partly with
   B1) amino-functional compounds having molecular weights of from 32 to 1,000 g/mol, preferably 32 to 400 g/mol
   with chain lengthening,
      the prepolymers being dissolved in one or more organic solvents before, during or after step B).

Preferably, the polyurethane solutions to be used according to the invention have solids contents of from 5 to 70 wt. %, particularly preferably 15 to 60 wt. %, very particularly preferably 20 to 40 wt. %, based on the total weight of the polyurethane solution.

Suitable polyisocyanatcs of component A1) are the aliphatic, aromatic or cycloaliphatic polyisocyanates having an NCO functionality of greater than or equal to 2 which are known per se to the person skilled in the art.

Examples of such suitable polyisocyanates are 1,4-butylene-diisocyanate, 1,6-hexamethylene-diisocyanate (HDI), isophorone-diisocyanate (IPDI), 2,2,4- and/or 2,4,4-trimethylhexamethylene-diisocyanate, the isomeric bis-(4,4′-isocyanatocyclohexyl)-methanes or mixtures thereof of any desired isomer content, 1,4-cyclohexylene-di-isocyanate, 4-isocyanatomethyl-1,8-octane-diisocyanate (nonane-triisocyanate), 1,4-phenylene-diisocyanate, 2,4- and/or 2,6-toluylene-diisocyanate, 1,5-naphthylene-diisocyanate, 2,2′- and/or 2,4′- and/or 4,4′-diphenylmethane-diisocyanate, 1,3- and/or 1,4-bis-(2-isocyanato-prop-2-yl)-benzene (TMXDI), 1,3-bis(isocyanato-methyl)benzene (XDI) and alkyl 2,6-diisocyanatohexanoates (lysine-diisocyanates) with C1-C8-alkyl groups.

In addition to the abovementioned polyisocyanates, a proportion of modified diisocyanates which have a functionality of ≧2 with a uretdione, isocyanurate, urethane, allophanate, biuret, iminooxadiazinedione or oxadiazinetrione structure and mixtures of these can also be employed.

The polyisocyanates are preferably polyisocyanates or polyisocyanate mixtures of the abovementioned type with exclusively aliphatically or cycloaliphatically bonded isocyanate groups or mixtures of these and an average NCO functionality of the mixture of from 2 to 4, preferably 2 to 2.6 and particularly preferably 2 to 2.4. In very particularly preferred embodiments, these are difunctional isocyanate units, preferably difunctional aliphatic isocyanate units.

Particularly preferably, hexamethylene-diisocyanate, isophorone-diisocyanate or the isomeric bis-(4,4′-isocyanatocyclohexyl)methanes and mixtures of the above-mentioned diisocyanates are employed in A1). In a very particularly preferred embodiment, a mixture of hexamethylene-diisocyanate and isophorone-diisocyanate is employed.

Polymeric polyols having a number-average molecular weight Mₙ of from 400 to 8,000 g/mol, preferably from 400 to 6,000 g/mol and very particularly preferably from 600 to 3,000 g/mol are employed in A2). These preferably have an OH functionality of from 1.5 to 6, particularly preferably from 1.8 to 3, very particularly preferably from 1.9 to 2.1.

Such polymeric polyols are the polyester polyols, polyacrylate polyols, polyurethane polyols, polycarbonate polyols, polyether polyols, polyester-polyacrylate polyols, polyurethane-polyacrylate polyols, polyurethane-polyester polyols, polyurethane-polyether polyols, polyurethane-polycarbonate polyols and polyester-polycarbonate polyols known per se in polyurethane lacquer technology. These can be employed in A2) individually or in any desired mixtures with one another.

Suitable polyester polyols are the polycondensates, which are known per se, of di- and optionally tri- and tetraols and di- and optionally tri- and tetracarboxylic acids or hydroxycarboxylic acids or lactones. Instead of the free polycarboxylic acids, the corresponding polycarboxylic acid anhydrides or corresponding polycarboxylic acid esters of lower alcohols can also be used for preparation of the polyesters.

Examples of suitable diols are ethylene glycol, butylene glycol, diethylene glycol, triethylene glycol, polyalkylene glycols, such as polyethylene glycol, and furthermore 1,2-propanediol, 1,3-propanediol, butane-1,3-diol, butane-1,4-diol, hexane-1,6-diol and isomers, neopentyl glycol or hydroxypivalic acid neopentyl glycol ester, hexane-1,6-diol and isomers, butane-1,4-diol, neopentyl glycol and hydroxypivalic acid neopentyl glycol ester being preferred. In addition, polyols, such as trimethylolpropane, glycerol, erythritol, pentaerythritol, trimethylolbenzene or trishydroxyethyl isocyanurate, can also be employed.

Dicarboxylic acids which can be employed are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. The corresponding anhydrides can also be used as the source of acid.

If the average functionality of the polyol to be esterified is >2, monocarboxylic acids, such as benzoic acid and hexanecarboxylic acid, can additionally also be co-used.

Preferred acids are aliphatic or aromatic acids of the abovementioned type. Adipic acid, isophthalic acid and phthalic acid are particularly preferred.

Hydroxycarboxylic acids which can be co-used as participants in the reaction in the preparation of a polyester polyol having terminal hydroxyl groups are, for example, hydroxycaproic acid, hydroxybutyric acid, hydroxydecanoic acid, hydroxystearic acid and the like. Suitable lactones are caprolactone, butyrolactone and homologues. Caprolactone is preferred.

Suitable polycarbonate polyols are polycarbonates containing hydroxyl groups, preferably polycarbonate diols, having number-average molecular weights Mₙ of from 400 to 8,000 g/mol, preferably 600 to 3,000 g/mol. These are obtainable by reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol polybutylene glycols, bisphenol A and lactone-modified diols of the abovementioned type.

Preferably, the diol component comprises 40 to 100 wt. % of hexanediol, and 1,6-hexanediol and/or hexanediol derivatives are preferred. Such hexanediol derivatives are based on hexanediol and have ester or ether groups in addition to terminal OH groups. Such derivatives are obtainable by reaction of hexanediol with excess caprolactone or by self-etherification of hexanediol to give di- or trihexylene glycol.

Instead of or in addition to pure polycarbonate diols, polyether-polycarbonate diols can also be employed in A2).

Polycarbonates containing hydroxyl groups are preferably linear in structure.

Suitable polyether polyols are, for example, the polytetramethylene glycol polyethers known per se in polyurethane chemistry, such as are obtainable by polymerization of tetrahydrofuran by means of cationic ring-opening.

Suitable starter molecules which can be employed are all the compounds known from the prior art, such as, for example, water, butyl diglycol, glycerol, diethylene glycol, trimethylolpropane, propylene glycol, sorbitol, ethylenediamine, triethanolamine and 1,4-butanediol.

Preferred components in A2) are polytetramethylene glycol polyethers and polycarbonate polyols or mixtures thereof, and polytetramethylene glycol polyethers are particularly preferred.

Polyols of the molecular weight range mentioned having up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, trimethylolethane, glycerol, pentaerythritol and any desired mixtures thereof with one another, can be employed in A3).

Ester diols of the molecular weight range mentioned, such as α-hydroxybutyl-∈-hydroxy-caproic acid esters, ω-hydroxyphenyl-γ-hydroxybutyric acid ester, adipic acid (β-hydroxyethyl) ester or terephthalic acid bis(β-hydroxyethyl) ester, are also suitable.

Monofunctional isocyanate-reactive compounds containing hydroxyl groups can furthermore also be employed in A3). Examples of such monofunctional compounds are methanol, ethanol, iso-propanol, n-propanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol and 1-hexadecanol. If such alcohols react with the isocyanate-functional prepolymer, the contents which have reacted accordingly are no longer counted among the solvents.

Organic di- or polyamines, such as, for example, 1,2-ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 4,4-diaminodicyclohexylmethane, hydrazine hydrate and/or dimethylethylenediamine, can be employed as component B1).

Compounds which, in addition to a primary amino group, also contain secondary amino groups or, in addition to an amino group (primary or secondary), also contain OH groups can moreover also be employed as component B1). Examples of these are primary/secondary amines, such as diethanolamine, 3-amino-1-methylaminopropane, 3-amino-1-ethylaminopropane, 3-amino-1-cyclohexylaminopropane and 3-amino-1-methylaminobutane, and alkanolamines, such as N-aminoethylethanolamine, ethanolamine, 3-aminopropanol and neopentanolamine.

Monofunctional isocyanate-reactive amine compounds can also furthermore be employed as component B1), such as, for example, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amidoamines from diprimary amines and monocarboxylic acid, a monoketime of diprimary amines and primary/tertiary amines, such as N,N-dimethylaminopropylamine.

1,2-Ethylenediamine, bis(4-aminocyclohexyl)methane, 1,4-diaminobutane, isophoronediamine, ethanolamine, diethanolamine and diethylenetriamine are preferably employed.

The units A1). A2), A3) and B1) are preferably chosen such that no or only a low content of branching sites is formed in the polyurethane, since otherwise a high solution viscosity results. Particularly preferably, exclusively units having an average functionality of <2.2 are employed, very particularly preferably having an average functionality of <2.05. In a particularly preferred embodiment, exclusively difunctional and monofunctional units are employed, and in a very particularly preferred embodiment exclusively difunctional units are employed.

In a preferred embodiment for the preparation of the specific polyurethane solutions, components A1) to A3) and B1) are employed in the following amounts for the preparation of the polyurethane, i.e. are incorporated into the polyurethane, the individual amounts always adding up to 100 wt. %:

5 to 40 wt. % of component A1),
55 to 90 wt. % of component A2),
0 to 10 wt. % of component A3) and
1 to 15 wt. % of component B1).

In a particularly preferred embodiment for the preparation of the specific polyurethane solutions, components A1) to A3) and B1) are employed in the following amounts for the preparation of the polyurethane, i.e. are incorporated into the polyurethane, the individual amounts always adding up to 100 wt. %:

5 to 35 wt. % of component A1),
60 to 85 wt. % of component A2).
0 to 5 wt. % of component A3) and
3 to 10 wt. % of component B1).

In a very particularly preferred embodiment for the preparation of the specific polyurethane solutions, components A1) to A3) and B1) are employed in the following amounts for the preparation of the polyurethane. i.e. are incorporated into the polyurethane, the individual amounts always adding up to 100 wt. %:

10 to 30 wt. % of component A1),
65 to 85 wt. % of component A2),
0 to 3 wt. % of component A3) and
3 to 8 wt. % of component B1).

The abovementioned amounts of the individual components A1). A2), A3) and B1) designate the amounts employed for building up the polyurethane and do not take into account additional amounts of these components which may be present or added as a solvent.

A dissolving step can be carried out before, during or after the completed or partial polyaddition of A1), A2) and optionally A3). A dissolving step can also be carried out during or after addition of B1). Mixtures of at least two organic solvents can be employed, or only one organic solvent. Mixtures of solvents are preferred.

For the preparation of the polyurethane solutions, preferably, all or portions of constituents A1), A2) and optionally A3) are initially introduced into a vessel for the preparation of an isocyanate-functional polyurethane prepolymer and the mixture is optionally diluted with a solvent which is inert towards isocyanate groups and heated up to temperatures in the range of from 50 to 120° C. The catalysts known in polyurethane chemistry can be employed for acceleration of the isocyanate addition reaction.

The constituents of A1), A2) and optionally A3) which optionally have not yet been added at the start of the reaction are then metered in.

In the preparation of the polyurethane prepolymer from A1), A2) and optionally A3), the ratio of the substance amounts of isocyanate groups to isocyanate-reactive groups is in general 1.05 to 3.5, preferably 1.1 to 3.0, particularly preferably 1.1 to 2.5.

Isocyanate-reactive groups are to be understood as meaning all groups which are reactive towards isocyanate groups, such as, for example, primary and secondary amino groups, hydroxyl groups or thiol groups.

The reaction of components A1), A2) and optionally A3) to give the prepolymer is carried out to partial completion or completion, but preferably to completion. Polyurethane prepolymers which contain free isocyanate groups are obtained in this way in bulk or in solution.

Thereafter, in a further process step, if this has not yet taken place or has only partly taken place, the prepolymer obtained is dissolved with the aid of one or more organic solvents.

In the chain lengthening in stage B), NH₂- and/or NH-functional components are reacted with the isocyanate groups of the prepolymer which still remain.

The degree of chain lengthening, that is to say the ratio of equivalents of NCO-reactive groups of the compounds under B) employed for chain lengthening and chain termination to the free NCO groups of the prepolymer prepared under A), is in general between 50 and 150%, preferably between 50 and 120%, particularly preferably between 60 and 110% and very particularly preferably about 100%.

The aminic components B1) can optionally be employed in solvent-diluted form in the process according to the invention, individually or in mixtures, in principle any sequence of addition being possible. Alcoholic solvents can also be employed for chain lengthening or chain termination. In this context, as a rule only a part of the alcoholic solvents contained in the mixture is incorporated into the polymer chain.

If organic solvents are co-used as diluents, the diluent content in the component for chain lengthening employed in B) is preferably 1 to 95 wt. %, particularly preferably 3 to 50 wt. %, based on the total weight of component B1) including diluents.

The film-forming compositions according to the invention typically contain at least 5 wt. % of polyurethane, based on the solids content of all the components contained in the composition. i.e. based on the total solids content. Preferably, however, the compositions contain at least 30 wt. %, particularly preferably at least 60 wt. % and very particularly preferably 70 to 99 wt. % of polyurethane, based on the total solids content.

Suitable solvents for the polyurethane solutions according to the invention are, for example, esters, such as e.g. ethyl acetate or methoxypropyl acetate, or butyrolactone, alcohols, such as e.g. methanol, ethanol, n-propanol or isopropanol, ketones, such as e.g. acetone or methyl ethyl ketone, ethers, such as e.g. tetrahydrofuran or tert-butyl methyl ether, aromatic solvents, such as e.g. toluene, xylene or solvent naphtha, or solvents containing amide or urea groups, such as e.g. dimethylformamide or N-methylpyrrolidinone. Esters, alcohols, ketones and/or ethers are preferably employed. Particularly preferably, the solutions contain at least one alcohol, preferably at least one aliphatic alcohol, particularly preferably at least one aliphatic alcohol having 1 to 6 carbon atoms, such as, for example, methanol, ethanol, n-propanol and/or isopropanol, and at least one further solvent chosen from the groups of esters, ketones or ethers. The particularly preferred content of alcoholic solvents is 10 to 80 wt. %, very particularly preferably 25 to 65 wt. %, based on the total weight of all the solvents. Alcohols are called solvents in the context of the invention as long as they are added after formation of the isocyanate-functional prepolymer. The content of alcohols which is employed as a hydroxy-functional compound A3) in the preparation of the isocyanate-functional prepolymer and is incorporated covalently into this does not count as the solvents.

Preferably, the solution of at least one polyurethane in one or more organic solvents which is to be used according to the invention contains less then 5 wt. %, preferably less than 1 wt. %, particularly preferably less than 0.3 wt. % of water, based on the total weight of the solution.

If polyurethane is not employed exclusively as the film-forming polymer, other polymers, optionally in the form of solutions in one or more organic solvents, can furthermore be co-employed, e.g. based on polyesters, poly(meth)acrylates, polyepoxides, polyvinyl acetates, polyethylene, polystyrene, polybutadienes, polyvinyl chloride and/or corresponding copolymers.

The polymer solutions to be used according to the invention can additionally also contain auxiliary substances and additives. Examples of such auxiliary substances and additives are crosslinking agents, thickeners, co-solvents, thixotropic agents, stabilizers, antioxidants, light stabilizers, plasticizers, pigments, fillers, hydrophobizing agents and flow agents.

The polymer solutions to be used according to the invention can additionally also contain fillers which regulate the dielectric constant of the polymer layer. For certain uses, polymer solutions without such fillers may be preferred. For other uses, polymer solution which contain additions of specific fillers to increase the dielectric constant, such as e.g. electrically conductive fillers or fillers having a high dielectric constant, may be preferred. Examples of such specific fillers are carbon black, graphite or single-walled or multi-walled carbon nanotubes.

Additives for increasing the dielectric constant and/or the discharge field strength can also additionally be added after the film formation, for example by generation of one or more further layer(s) or for penetration of the layer.

The solutions to be used according to the invention can be applied by all the forms of application known per se, and there may be mentioned, for example, knife coating, brushing, pouring or spraying.

A multi-layer application with drying steps optionally in between is also possible in principle.

For faster drying and fixing, temperatures above 20° C. are preferably used. Temperatures of between 30 and 200° C. are preferred. Drying in two or more stages with correspondingly increasing temperature gradients is also appropriate in order to prevent boiling of the polymer layer. Drying is as a rule carried out using heating and drying apparatuses known per se, such as (circulating air) drying cabinets, hot air or IR lamps. Drying by guiding the coated substrate over heated surfaces, e.g. rollers, is also possible. The application and the drying can in each case be carried out discontinuously or continuously, but a completely continuous process is preferred.

The polymer layer prepared by means of the use according to the invention of the film-forming compositions can be provided with further layers. This can be effected on one side or both sides, in one layer or in several layers one on top of the other, and by complete coating or coating of a part area of the film.

Suitable carrier materials for the production of the polymer layer are, in particular, glass, release paper, films and plastics, from which the polymer layer can optionally be removed again easily. In preferred embodiments of the invention, one of the electrodes for the converter to be produced is used directly as the carrier material for the production of the polymer layer, so that subsequent detachment of the polymer layer is no longer necessary.

Processing of the individual layers is carried out by pouring or manual or mechanically performed knife coating; printing, screen printing and spraying or misting and dipping are also possible processing techniques. Generally, all techniques which can be employed for application of thin layers—e.g. for lacquering—are conceivable.

The polymer layers from the film-forming compositions have a good mechanical strength and high elasticity. Typically, the values for the tensile strength are greater than 10 MPa and the elongation at break is greater than 250%. Preferably, the tensile strength is between 10 and 100 MPa and the elongation at break is greater than 350%.

After drying, the polymer layers typically have a thickness of from 0.1 to 1,500 μm, preferably 1 to 500 μm, particularly preferably 5 to 200 μm, very particularly preferably 5 to 50 μm.

For construction of an energy converter, the polymer layers are coated with electrodes on both sides, as is described, for example, in WO-A 01/06575. If the polymer layer has already been produced on an electrode as the carrier material, only coating of the other side with a further electrode is necessary.

The present invention therefore furthermore provides a process for the production of a converter for conversion of electrical energy into mechanical energy or of mechanical energy into electrical energy, which comprises at least two electrodes and a polymer layer arranged between the electrodes, characterized in that
a) polymer layer is produced from a solution of at least one polyurethane in one or more organic solvents,
wherein
b1) either the polymer layer is produced by direct application of the solution to an electrode and is then coated with a further electrode from the other side, or
b2) the polymer layer is coated with electrodes from both sides after production according to a).

The electrode materials can be conductive materials known to the person skilled in the art. Materials which are possible for this are, for example, metals, metal alloys, conductive oligo- or polymers, such as e.g. polythiophenes, polyanilines, polypyrroles, conductive oxides, such as e.g. mixed oxides, such as ITO, or polymers filled with conductive fillers. Possible fillers for polymers filled with conductive fillers are, for example, metals, conductive carbon-based materials, such as e.g. carbon black, carbon nanotubes (CNTs), or conductive oligo- or polymers. In this context, the filler content of the polymers is above the percolation threshold, which is characterized in that the conductive fillers form continuous electrically conductive paths. The polymers filled with conductive fillers are preferably elastomers. For particularly preferred uses in which the elasticity of the entire converter is of interest, electrode materials which are preferably suitable are, for example, elastic electrode materials, such as e.g. conductive oligo- or polymers or polymers filled with conductive fillers.

The electrodes can be applied by means of processes known to the person skilled in the art. Possible processes for this are, for example, processes such as sputtering, vapour deposition, chemical vapour deposition (CVD), printing, knife coating and spin coating. The electrodes can also be glued on in prefabricated form.

The electromechanical converters according to the invention comprise at least two electrodes. Electromechanical converters with more than two electrodes can be, for example, stack structures. Electromechanical converters comprising two electrodes are preferred.

The electromechanical converters according to the invention comprising at least two electrodes and at least one polymer layer arranged between the electrodes can be employed in the most diverse configurations for the production of sensors, actuators or generators.

The present invention therefore furthermore provides actuators, sensors or generators comprising such a converter according to the invention or a polymer layer produced from a polyurethane solution containing at least one polyurethane in one or more organic solvents, and a process for the production of actuators, sensors or generators employing such a converter according to the invention or a polymer payer produced from a polyurethane solution containing at least one polyurethane in one or more organic solvents.

The present invention furthermore provides electronic and electrical equipment, devices, apparatuses, units, machines, components and instruments containing corresponding actuators, sensors or generators.

In particular, the generators and the devices comprising these generators can advantageously be used for so-called “energy harvesting”, preferably for the conversion of water wave energy into electrical current, particularly preferably for the conversion of sea wave energy into electrical current.

The following examples serve to explain and illustrate the invention by way of example and are in no way to be interpreted as a limitation.

### EXAMPLES

Unless identified otherwise, all the percentage data relate to the weight.

Unless noted otherwise, all the analytical measurements are based on temperatures of 23° C.

The solids contents were determined in accordance with DIN-EN ISO 3251.

Unless expressly mentioned otherwise, NCO contents were determined volumetrically in accordance with DIN-EN ISO 11909.

Monitoring for free NCO groups was carried out by means of IR spectroscopy (band at 2260 cm⁻¹).

The viscosities stated were determined by means of rotary viscometry in accordance with DIN 53019 at 23° C. with a rotary viscometer from Anton Paar Germany GmbH, Ostfildern, Del.

Fillers were incorporated into the solutions according to the invention with a Speedmixer (model 150 FV from Hauschild & Co KG, Postfach 4380, D-59039 Hamm).

Measurements of the film layer thicknesses were performed with a mechanical scanner from Heidenhain GmbH, Postfach 1260, D-83292 Traunreut. The test specimens were measured at three different points and the mean was used as the representative measurement value.

The tensile tests were carried out with a tensile machine from Zwick, model number 1455, equipped with a load cell of the total measurement range of 500 N in accordance with DIN 53455 with a drawing speed of 50 mm/min. S2 tensile bars were employed as test specimens. Each measurement was performed on three test specimens prepared in the same way and the mean of the data obtained was used for the evaluation. In addition to the tensile strength TS in [MPa] and the elongation at break EB in [%], the stress ST in [MPa] at 100% (=ST100) and 200% (=ST200) elongation were determined specifically for this.

The electrical resistivity R was determined with a measurement construction from Keithley Instruments Inc., 28775 Aurora Road, Cleveland, Ohio 44139, phone: (440) 248-0400, (electrometer: model number 6517A; measuring head: model number 8009) and a program supplied with this (model number 6524: high resistance measurement software). A symmetric square wave voltage of +/−50 V was applied for the duration of 4 min per period for the duration of 10 periods and the current flow was determined. From the values for the current flow shortly before switching of the voltage, the resistance of the test specimen was calculated for each period of the voltage and plotted against the period number. The end value of this plot gives the measurement value for the electrical resistivity of the specimen.

Measurements of the dielectric constant DC were performed with a measurement construction from Novocontrol Technologies GmbH & Co. KG, Obererhacher Straβe 9, 56414 Hundsangen/GERMANY, phone: +49 6435-96 23-0 (measuring bridge: Alpha-A Analyzer, measuring head: ZGS active sample cell test interface) with a diameter of the test specimens of 20 mm. A frequency range of from 10⁷ to 10⁻² Hz was investigated here. As a measure of the dielectric constant of the material investigated, the real component of the dielectric constant at 10⁻² Hz was chosen.

The measurements of the water uptake (WU) were performed by storing the polymer Films at room temperature under a saturated water vapour atmosphere in a closed vessel for 72 h. For this, 1 g of the polymer film was weighed precisely and stored for 72 h in a BOLA desiccator (model V-1922, product of Bohlender GmbH, Waltersberg 8, D-97947 Grünsfeld), which additionally contains a dish with water in the lower region. After the storage lasting 72 h, the film was removed from the desiccator and weighed immediately. The difference in weight from the starting weight is the water uptake WU in %.

### Substances Used and Abbreviations:

Diaminosulfonate: NH₂—CH₂CH₂—NH—CH₂CH₂—SO₃Na (45% strength in water)
Desmophen® 2020/C2200: polycarbonate polyol, OH number 56 mg of KOH/g, number-average molecular weight 2,000 g/mol (Bayer MaterialScience AG, Leverkusen, Del.)
Polyether LB 25: monofunctional polyether based on ethylene oxide/propylene oxide, number-average molecular weight 2.250 g/mol, OH number 25 mg of KOH/g (Bayer MaterialScience AG, Leverkusen, Del.)
PolyTHF® 2000: polytetramethylene glycol polyol, OH number 56 mg of KOH/g, number-average molecular weight 2,000 g/mol (BASF AG, Ludwigshafen, De)
PolyTHF® 1000: polytetramethylene glycol polyol, OH number 112 mg of KOH/g, number-average molecular weight 1,000 g/mol (BASF AG, Ludwigshafen, Del.)

### Example 1

### Polymer Layers from a Polyurethane Solution (According to the Invention)

200 g of PolyTHF® 2000 and 50 g of PolyTHF® 1000 were heated up to 80° C. in a standard stirred apparatus. A mixture of 66.72 g of isophorone-diisocyanate and 520 g of methyl ethyl ketone was then added at 80° C. in the course of 5 min and the mixture was stirred under reflux until the theoretical NCO value was reached (approx. 8 hours). The finished prepolymer was cooled to 20° C. and a solution of 25.2 g of methylenebis(4-aminocyclohexane) and 519.5 g of isopropanol was then metered in over a period of 30 min. Stirring was then continued until free isocyanate groups were no longer detectable by IR spectroscopy.

The clear solution obtained had the following properties:

| | |
|---|---|
| Solids content: | 25% |
| Viscosity (viscometer, 23° C.): | 4,600 mPas |

The solution employed for the production of a particular polymer layer was not degassed separately. The required amount of 100 g of solution according to the invention was weighed into a polypropylene beaker (PP beaker). Layers of wet layer thickness 1 mm were knife-coated manually on glass plates from the still liquid reaction mixture. All the layers were dried at 30° C. overnight in a drying cabinet after production, and then after-conditioned at 120° C. for 5 min. It was possible to detach the layers as films easily from the glass plate manually after the conditioning.

### Example 2

### Polymer Layers from an Aqueous Polyurethane Dispersion (Comparison Example)

450 g of PolyTHF® 1000 and 2,100 g of PolyTHF® 2000 were heated up to 70° C. A mixture of 225.8 g of hexamethylene-diisocyanate and 298.4 g of isophorone-diisocyanate was then added at 70° C. in the course of 5 min and the mixture was stirred at 100-115° C. until the NCO value was below the theoretical value. The finished prepolymer was dissolved with 5,460 g of acetone at 50° C. and a solution of 29.5 g of ethylenediamine, 143.2 g of diaminosulfonate and 610 g of water was then metered in over a period of 10 min. The after-stirring time was 15 min. Thereafter, the product was dispersed in the course of 10 min by addition of 1,880 g of water. Removal of the solvent by distillation in vacuo followed and a storage-stable dispersion was obtained.

| Solids content: | 56% | |
|---|---|---|
| Particle size (LCS): | 276 | nm |
| Viscosity: | 1,000 | mPas |

The raw materials employed were not degassed separately. The required amount of 100 g of dispersion was weighed into a PP beaker. Layers of wet layer thickness 1 mm were knife-coated manually on glass plates from the still liquid reaction mixture. All the layers were dried at 30° C. overnight in a drying cabinet after production, and then after-conditioned at 120° C. for 5 min. It was possible to detach the layers as films easily from the glass plate manually after the conditioning.

### Example 3

### Polymer Layers from a Two-Component Polyurethane System (2c PU System, Comparison Example)

All the liquid raw materials were degassed thoroughly under argon in a three-stage process. 10 g of Terathane 650 (INVISTA GmbH, D-65795 Hatterheim, Poly-THF of molar mass Mn=650) were weighed into a 60 ml disposable mixing container (APM-Technika AG, order no. 1033152). 0.005 g of dibutyltin dilaurate (Metacure® T-12, Air Products and Chemicals, Inc.) and 6.06 g of the isocyanate N3300 (the isocyanurate trimer of HDI; product of Bayer MaterialScience AG) were then weighed into this and the components were mixed at 3,000 rpm in a Speedmixer for 1 min. The reaction product was poured on to a glass plate and drawn out to homogeneous layers with a knife of wet layer thickness 1 mm. The layers were then conditioned at 80° C. for 16 h, and after the conditioning it was possible to peel them off from the glass plate manually as films.

### Example 4

### Polymer Layers from an Aqueous Polyurethane Dispersion (Comparison Example)

82.5 g of PolyTHF® 1000, 308 g of PolyTHF® 2000 and 10.0 g of 2-ethylhexanol were heated up to 70° C. A mixture of 41.4 g of hexamethylene-diisocyanate and 54.7 g of isophorone-diisocyanate was then added at 70° C. in the course of 5 min and the mixture was stirred at 110-125° C. until the NCO value was below the theoretical value. The finished prepolymer was dissolved with 880 g of acetone at 50° C. and a solution of 3.8 g of ethylenediamine, 4.6 g of isophoronediamine, 26.3 g of diaminosulfonate and 138 g of water was then metered in over a period of 10 min. The after-stirring time was 15 min. Thereafter, dispersing was carried out in the course of 10 min by addition of 364 g of water. Removal of the solvent by distillation in vacuo followed and a storage-stable dispersion was obtained.

| | | |
|---|---|---|
| Particle size (LCS): | 181 | nm |
| Viscosity: | 1,300 | mPas |

The raw materials employed were not degassed separately. The required amount of 100 g of dispersion was weighed into a PP beaker. Layers of wet layer thickness 1 mm were knife-coated manually on glass plates from the still liquid reaction mixture. All the layers were dried at 30° C. overnight in a drying cabinet after production, and then after-conditioned at 120° C. for 5 min. It was possible to detach the layers as films easily from the glass plate manually after the conditioning.

### Example 5

### Polymer Layers from an Aqueous-Colloidal Polychloroprene Dispersion (Comparison Example)

100 g of an aqueous-colloidal dispersion of a polymer of 2-chlorobutadiene having a polymer content of 55 wt. %, a viscosity of approx. 100 mPas and a pH of approx. 13, commercially obtainable under the trade name Dispercoll® C 84 from Bayer MaterialScience AG. Leverkusen were weighed into a PP beaker. Layers of wet layer thickness 1 mm were knife-coated manually on glass plates from the still liquid reaction mixture. All the layers were dried at 30° C. overnight in a drying cabinet after production, and then after-conditioned at 120° C. for 5 min. It was possible to detach the layers as films easily from the glass plate manually after the conditioning.

### Films Data:

| | EB | TS | ST100 | ST200 | R | WU |
|---|---|---|---|---|---|---|
| Films | [%] | [MPa] | [MPa] | [MPa] | [ohm · cm] | [%] |
| Ex. 1* | 540 | 33.5 | 2.94 | 3.88 | 4.5 * 10¹² | 0.93 |
| Ex. 2 | 620 | 26.6 | 2.2 | 2.7 | 7.3 * 10¹⁰ | 2.70 |
| Ex. 3 | 44 | 1.7 | — | — | 2.3 * 10¹¹ | 1.12 |
| Ex. 4 | 1432 | 3.4 | 0.46 | 0.58 | 4.8 * 10¹¹ | 8.99 |
| Ex. 5 | 793 | 22.4 | 3.2 | 4.1 | 1.1 * 10¹² | 10.52 |

*according to the invention

It was found in the tests that films produced using, according to the invention, the polyurethane solutions offer significant advantages over those films produced from multi-component polyurethane systems or aqueous polymer dispersions.

When the films produced using, according to the invention, the polyurethane solutions are employed, the very good mechanical properties, such as high elasticity, high elongation at break, particularly suitable stress-strain course with low stress at moderate elongations in the use range when used, but very high tensile strength, high electrical resistance and very low water uptake, are particularly advantageous. In the context of the invention, good mechanical properties were to be understood as meaning an elongation at break (EB) of at least 250%, a tensile strength (TS) of between 10 and 100 MPa, additionally a very flat stress-strain curve with stresses of below 5 MPa at moderate elongations in the range of about 100% to 200%, and an electrical resistivity (R) of more than 1*10¹² ohm·cm at a water uptake of less than 1%. In the comparison examples, either a stress could not be measured at 100% or 200%, since these materials are already torn at 40% to 60%, or the electrical conductivity was clearly too high. In particular, the comparison examples showed a water uptake (WU) which was clearly too high. On the other hand, the example according to the invention showed a particularly low water uptake of less than 1%.

The easy handling is furthermore an advantage of the use of the solution, since this is a one-component (1C) system; therefore no handling of reactive groups, such as e.g. free isocyanates, during incorporation of the fillers is necessary.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Process for the production of a converter for conversion of electrical energy into mechanical energy or of mechanical energy into electrical energy, which comprises at least two electrodes and at least one polymer layer arranged between the electrodes, wherein the polymer layer is produced from a solution containing at least one polyurethane in one or more organic solvents, characterized in that the solution originates from a prepolymerization process with the following steps:
A) preparation of isocyanate-functional prepolymers from
A1) organic polyisocyanates,
A2) polymeric polyols having a molecular weight (number-average) of from 400 to 8.000 g/mol and an average OH functionality of from 1.5 to 6 and
A3) optionally hydroxy-functional compounds having molecular weights of from 62 to 399 μmol and
B3) complete or partial reaction of the free NCO groups of the prepolymers from A) with
B1) amino-functional compounds having molecular weights of from 32 to 1,000 g/mol,
the prepolymers being dissolved in one or more organic solvents before, during and/or after step B).

2. Process according to claim 1, characterized in that component A2) comprises polyester polyols, polyacrylate polyols, polyurethane polyols, polycarbonate polyols, polyether polyols, polyester-polyacrylate polyols, polyurethane-polyacrylate polyols, polyurethane-polyester polyols, polyurethane-polyether polyols, polyurethane-polycarbonate polyols and polyester-polycarbonate polyols, polycarbonates containing hydroxyl groups, polyether-polycarbonate diols or mixtures of these, preferably polyether polyols, polycarbonate polyols or mixtures of these, particularly preferably polytetramethylene glycol polyethers.

3. Process according to claims 1 or 2, characterized in that component A1) comprises difunctional isocyanate units, preferably difunctional aliphatic isocyanate units, particularly preferably hexamethylene-diisocyanate, the isomeric bis-(4,4′-isocyanatocyclohexyl)methanes and/or isophorone-diisocyanate, and very particularly preferably a mixture of hexamethylene-diisocyanate and isophorone-diisocyanate.

4. Process according to at least one of claims 1 to 3, characterized in that esters, alcohols, ketones, ethers, aromatic solvents and/or solvents containing amide or urea groups or mixtures containing these, preferably esters, alcohols, ketones and/or ethers or mixtures containing these are used as the solvents.

5. Process according to at least one of claims 1 to 4, characterized in that the solvent or solvent mixture contains at least one alcohol, and preferably the content of alcohols is 10 to 80 wt. %, based on the total weight of the solvent or solvent mixture.

6. Process according to at least one of claims 1 to 5, characterized in that the solution containing at least one polyurethane in one or more organic solvents contains less then 5 wt. %, preferably less than 1 wt. %, particularly preferably less than 0.3 wt. % of water, based on the total weight of the solution.

7. Process according to at least one of claims 1 to 6, characterized in that
a) the polymer layer either is produced by direct application of the solution to an electrode and is then coated with a further electrode from the other side or
b) the polymer layer is coated with electrodes from both sides after production according to a)

8. Converter for conversion of electrical energy into mechanical energy or of mechanical energy into electrical energy, which comprises at least two electrodes and at least one polymer layer arranged between the electrodes, characterized in that the converter is obtainable by a process according to at least one of claims 1 to 7.

9. Actuator, sensor or generator comprising at least one converter according to claim 8.

10. Devices, in particular electronic and electrical equipment, which comprise at least one actuator, sensor or generator according to claim 9.

11. Use of a generator according to claim 9 or of a device according to claim 10 for the conversion of water wave energy, preferably sea wave energy, into electrical current.
